(19) United States
(12) Patent Application Publication
(10) Pub. No.: US 2007/0175185 A1
(43) Pub. Date: Aug. 2, 2007

(54) Dust separating apparatus

(75) Inventors: Tae-gwang Kim, Incheon (KR); Oh-kyu Kwon, Gyeonggi-do (KR); Jeong-hee Cho, Jeollabuk-do (KR)

Correspondence Address: Paul D. Greeley;Ohlandt, Greeley, Ruggiero & Perle, L.L.P., 10 Floor, One Landmark Square, Stamford, CT, 06901-2682, US

(73) Assignee: SAMSUNG GWANGJU ELECTRONICS CO., LTD

(21) Appl. No.: 11/529,005

(22) Filed: Sep. 28, 2006

Related U.S. Application Data
(60) Provisional application No. 60/762,933, filed on Jan. 27, 2006.

(30) Foreign Application Priority Data
Mar. 24, 2006 (KR) 10-2006-0026863

(51) Int. Cl. B01D 50/00

(52) U.S. Cl. 55/337

(57) ABSTRACT

The present disclosure relates to a dust separating apparatus using a centrifugal force. The dust separating apparatus includes a cyclone body configured to separate dust from air using centrifugal force, and having an entering pipe through which the air enters; a dust collecting receptacle configured to be detachably connected to a bottom end of the cyclone body, and for collecting dust separated from the air; and a filter unit configured to be detachably disposed to the cyclone body, wherein the filter unit has a compact, at least double structure formed by a filter for filtering large dust and a filter for filtering fine dust.

### CROSS-REFERENCE TO RELATED APPLICATIONS

This application claims the benefit under 35 U.S.C. § 119 from U.S. Provisional Application No. 60/762,933 filed Jan. 27, 2006 in the United States Patent & Trademark Office, and claims the benefit under 35 U.S.C. § 119 from Korean Patent Application No. 2006-26863 filed Mar. 24, 2006 in the Korean Intellectual Property Office, the disclosures of both of which are incorporated herein by reference in their entirety.

### BACKGROUND OF THE INVENTION

1. Field of the Invention

The present disclosure relates to a dust separating apparatus. More particularly, the present disclosure relates to a dust separating apparatus that causes air containing dust and/or contaminant particles to enter and to whirl so as to separate the dust and contaminant particles from the entering air, and has a filter unit filtering dust from the air passing therethrough.

2. Description of the Related Art

Generally, a dust separating apparatus is disposed at an air flowing path in front of a vacuum motor generating a vacuum inside a vacuum cleaner, and separates dust and/or contaminant particles from air before the air enters the vacuum motor.

Some dust separating apparatuses use a centrifugal force in order to separate dust from the air containing dust and/or contaminant particles. The dust separating apparatuses using centrifugal force cause outside air to enter through a side of the dust separating apparatus and to whirl inside dust separating apparatus. As a result, dust and contaminant particles being heavier than the air are separated from the whirling air by the centrifugal force.

The conventional centrifugal dust separating apparatus includes an air drawing port, a cyclone body, a filter disposed inside the cyclone body, a dust collecting receptacle, and an air discharging port. The air drawing port is disposed at a side of the cyclone body, and causes the outside air to enter through the side of the cyclone body and to whirl inside the cyclone body so that the dust is separated from the outside air by the difference in the centrifugal force operating upon each of the dust and the air, and the separated dust is collected in the dust collecting receptacle disposed under the cyclone body. When the air having dust separated passes through the filter disposed at an air flowing path in front of the air discharging port, dust is separated once more. Then, clean air is discharged to the vacuum motor generating the vacuum. However, the conventional dust separating apparatus has a problem that fine dust having a weight substantially similar to that of the air is likely to pass through the filter to the vacuum motor so that the collecting efficiency for fine dust is low.

To solve the problem, there is provided with a vacuum cleaner having a dust-collecting member disposed at the vacuum cleaner in addition to the centrifugal dust separating apparatus in order to filter fine dust before the air enters the vacuum generator. Also, there is provided with a centrifugal dust separating apparatus having a separate dust collecting member for collecting fine dust and disposed at downstream of the air discharging port that is disposed at any of a top side or a bottom side of the dust separating apparatus. However, when using the additional dust-collecting member, the vacuum cleaner needs a separate space in which the additional dust-collecting member is disposed so that the size of the vacuum cleaner is increased. Furthermore, when the centrifugal dust separating apparatus has a separate space for the dust collecting member at the top side or at the bottom side of the dust separating apparatus, the height of the dust separating apparatus is increased as high as the height of the separate space in which the dust collecting member for collecting fine dust is disposed so that the volume of the dust separating apparatus is increased. As a result, the size of the vacuum cleaner is increased.

### SUMMARY OF THE INVENTION

The present disclosure has been developed in order to overcome the above drawbacks and other problems associated with the conventional arrangement. An aspect of the present disclosure is to provide a dust separating apparatus using centrifugal force that increases the collecting efficiency for fine dust and has a compact size.

The above aspect and/or other feature of the present disclosure can substantially be achieved by providing a dust separating apparatus, which includes a cyclone body configured to separate dust from air using centrifugal force, and having an entering pipe through which the air enters; a dust collecting receptacle configured to be detachably connected to a bottom end of the cyclone body, and for collecting dust separated from the air; and a filter unit configured to be detachably disposed to the cyclone body, wherein the filter unit has a compact, at least double structure formed by a filter for filtering large dust and a filter for filtering fine dust. Therefore, the collecting efficiency for fine dust is increased, and a compact dust separating apparatus can be provided.

According to an embodiment of the present disclosure, the filter unit includes a grill filter for filtering large dust; a porous filter disposed inside the grill filter, and a supporting member for supporting the porous filter. Each of the grill filter, the porous filter, and the supporting member is formed in a substantially cylindrical shape with an air flowing path thereinside. Also, the porous filter is disposed between the grill filter and the supporting member, wherein the supporting member is configured to be mounted on or separated from the grill filter. Furthermore, the grill filter includes a grill part through which the air enters; a cylindrical part disposed above the grill part and through which the air cannot enter; and a locking part disposed at a top end of the cylindrical part and configured to be connected to or separated from the cyclone body. Therefore, users can simply separate the filter unit from the cyclone body so as to easily separate the porous filter from the filter unit and clean the porous filter.

Furthermore, the grill filter further comprises a skirt projecting from a bottom end of a circumferential surface of the grill filter and preventing dust from flowing back so as to reduce a dust backflow. Because at least a part of the entering pipe projects from a top surface of the cyclone body, the number of rotations of the entering air is increased so that dust-collecting apparatus is increased.

Also, the dust collecting receptacle comprises a discharging pipe projecting from a center of a bottom surface of the dust collecting receptacle, wherein the discharging pipe is detachably connected to a bottom end of the filter unit so as to guide the air flowing out the filter unit to be discharged outside. Therefore, the length of the air flowing path for the discharging air is decreased so that the piping pressure loss of the vacuum cleaner can be reduced.

Other objects, advantages and salient features of the disclosure will become apparent from the following detailed description, which, taken in conjunction with the annexed drawings, discloses preferred embodiments of the disclosure.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a perspective view illustrating a dust separating apparatus according to an embodiment of the present disclosure;

FIG. 2 is an exploded perspective view illustrating the dust separating apparatus of FIG. 1;

FIG. 3 is a partial sectional view illustrating a bottom end of a cyclone body of the dust separating apparatus taken along line 3-3 of FIG. 2;

FIG. 4 is a sectional perspective view illustrating a connection part and a locking part of the dust separating apparatus taken along line 4-4 of FIG. 1;

FIG. 5 is a sectional view illustrating the dust separating apparatus of FIG. 1 taken along line 5-5 of FIG. 1; and

FIG. 6 is a sectional perspective view illustrating the dust separating apparatus of FIG. 1.

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present disclosure will be described in detail with reference to the accompanying drawings.

The matters defined in the description, such as a detailed construction and elements thereof, are provided to assist in a comprehensive understanding of the disclosure. Thus, it is apparent that the present disclosure may be carried out without those defined matters. Also, well-known functions or constructions are omitted to provide a clear and concise description of exemplary embodiments of the present disclosure.

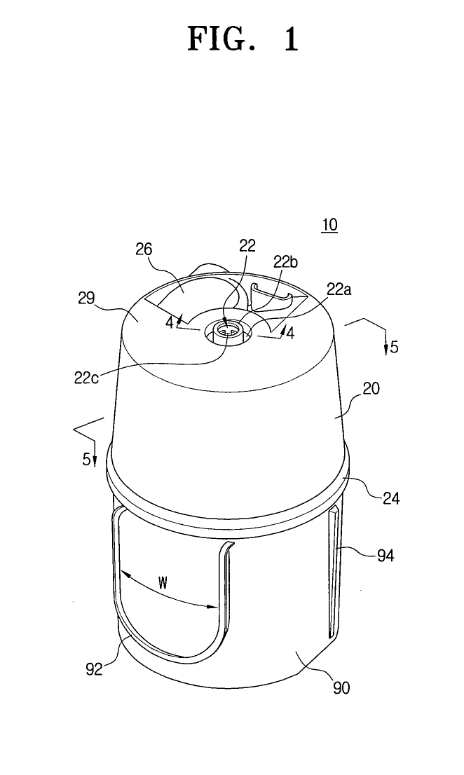

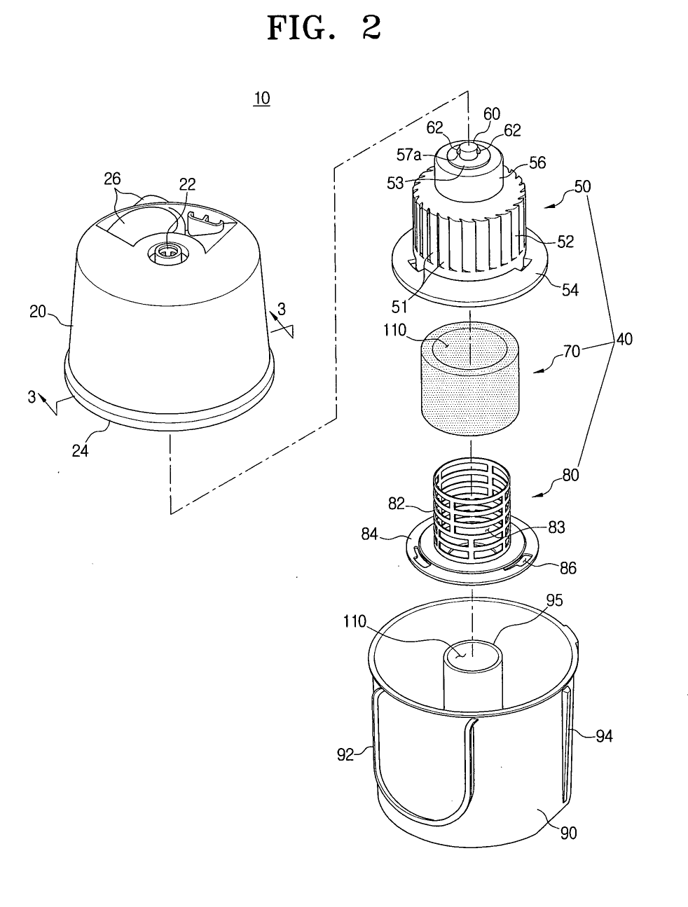

FIG. 1 is a perspective view illustrating a dust separating apparatus according to an embodiment of the present disclosure, and FIG. 2 is an exploded perspective view illustrating the dust separating apparatus of FIG. 1.

Referring to FIGS. 1 and 2, a dust separating apparatus 10 according to an embodiment of the present disclosure includes a cyclone body 20, a dust collecting receptacle 90, and a filter unit 40.

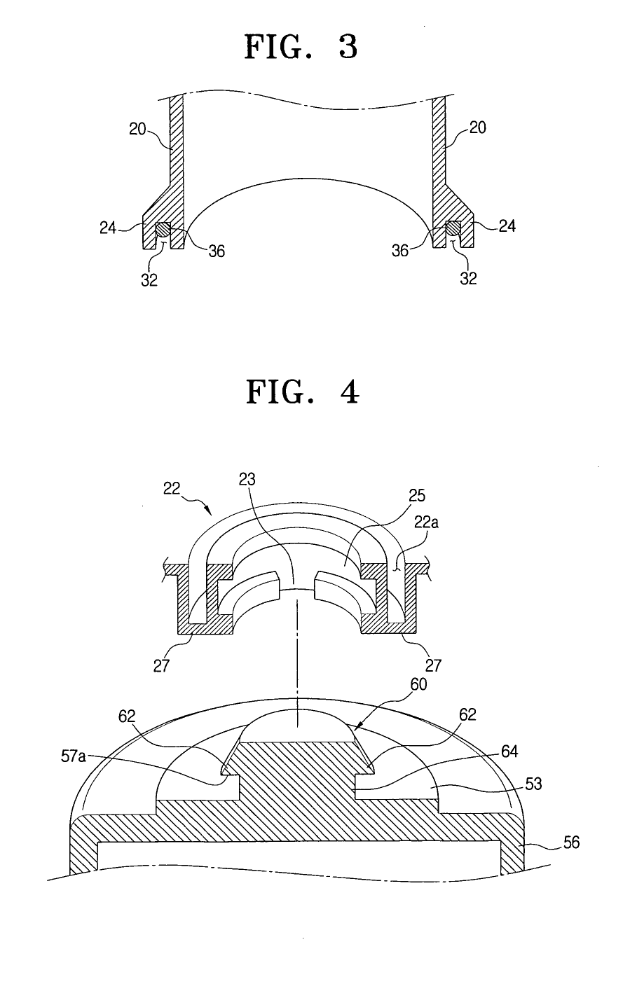

The cyclone body 20 is formed in a substantially cylindrical shape. An entering pipe 26 is disposed at a top of the cyclone body 20, and some portion of the entering pipe 26 projects from a top surface 29 of the cyclone body 20 so that outside air enters inside the cyclone body 20 through the entering pipe 26. As a result, the dust separating apparatus 10 according to this embodiment causes the entering air to whirl more than the conventional dust separating apparatus having the entering pipe 26 disposed below the top surface 29 of the cyclone body 20 so that the dust separating efficiency is increased. In a center of the top surface 29 of the cyclone body 20, there is a connection part 22 that can be detachably connected to the filter unit 40. As described below, a locking part 60 of a grill filter 50 is locked with the connection part 22 of the cyclone body 20 (see FIG. 4). In this embodiment, referring to FIG. 1, the connection part 22 formed inside the cyclone body 20 includes a sinking part 22a and a cylinder 22b projecting from a center of the sinking part 22a. A center space 22c of the cylinder 22b is in fluid communication with the inside of the cyclone body 20 so that users can see whether the filter unit 40 is locked with the connection part 22 from the outside. When the filter unit 40 is locked with the connection part 22, the inner space of the cyclone body 20 is shut off from outside and when the filter unit 40 is separated from the connection part 22, the inner space of the cyclone body 20 can be seen through the center space 22c. As shown in FIG. 4, a vertical groove 23 and a horizontal groove 25 are formed at the cylinder 22b of the connection part 22. The vertical groove 23 is formed vertically and comprises two vertical grooves 23 to face each other. The horizontal groove 25 is formed at the inner surface of the cylinder 22b in a circular shape. The locking part 60 is locked with the horizontal groove 25. The dust-collecting receptacle 90 is detachably disposed at a bottom end of the cyclone body 20. For sealing between the bottom end of the cyclone body 20 and the top end of the dust collecting receptacle 90, an edge projection 24 is formed at the bottom end of the cyclone body 20 in a circumferential direction, and a sealing groove 32 is formed at the edge projection 24 in a substantially circular shape as shown in FIG. 3. A sealing member 36, such as a rubber ring, is disposed inside the sealing groove 32 so that, when the top end of the dust collecting receptacle 90 is inserted into the sealing groove 32 to press the sealing member 36, the insides of the dust collecting receptacle 90 and the cyclone body 20 are completely isolated from outside.

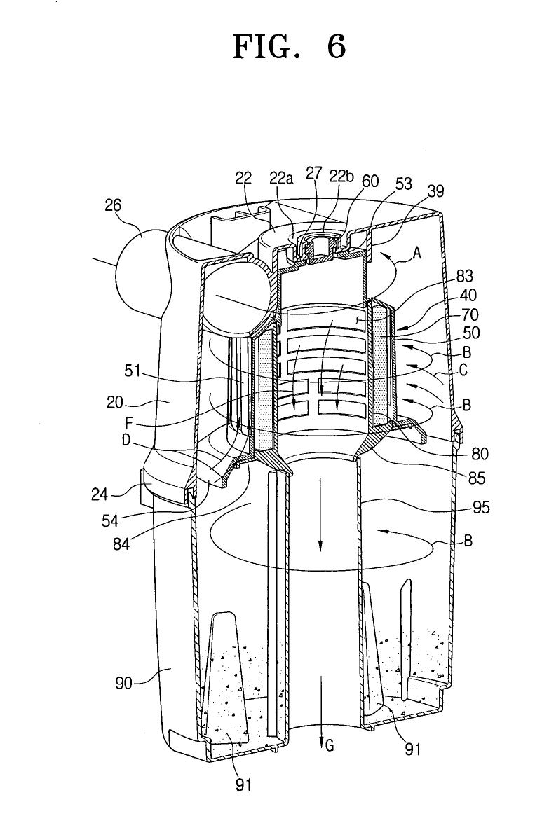

Referring to FIGS. 1 and 2, the dust collecting receptacle 90 is formed in a substantially cylindrical shape, and has a handle 92 projecting from an outer surface of the dust collecting receptacle 90 in a substantially U shape. The handle 92 has a width W of a span (e.g., about nine inches) or less so that a user can easily grip the handle 92 in his or her one hand. Referring to FIGS. 2 and 6, a discharging pipe 95 projects upwardly from a center of the inside of the dust-collecting receptacle 90. The discharging pipe 95 has a height of the substantially same as the height of the dust collecting receptacle 90. The cyclone body 20 is in fluid communication with outside via the discharging pipe 95. Also, three protrusions 91 are disposed at an inner bottom surface of the dust-collecting receptacle 90 at angular intervals of approximately 120 degrees. Referring to FIG. 6, the protrusions 91 are formed in a substantially trigonal pyramid with a width decreasing from a bottom end to a top end. Alternatively, the protrusions 91 may be formed in various shapes such as polygonal pyramids or cones. Dust collecting receptacle 90, as shown in FIGS. 1 and 2, includes one or more guiding members 94 (one shown) that guides the dust separating apparatus 10 to be mounted at a vacuum cleaner (not shown).

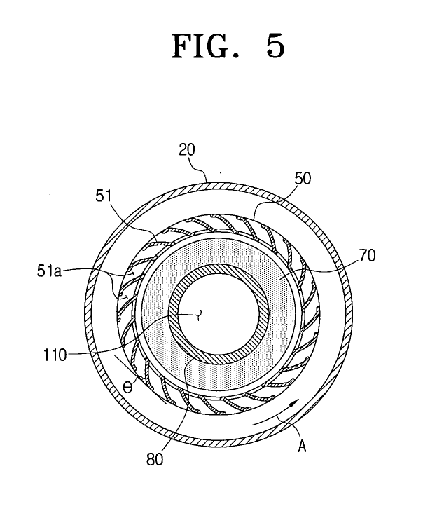

Referring to FIGS. 2, 4 and 5, the filter unit 40 includes a grill filter 50, a porous filter 70, and a supporting member 80. The porous filter 70 is disposed inside the grill filter 50, and the supporting member 80 is coupled to the inside of the porous filter 70 so that the grill filter 50, the porous filter 70, and the supporting member 80 form the compact filter unit 40 with a cylindrical air flowing path 110 thereinside as shown FIG. 5.

Referring to FIGS. 2, 4, and 5, the grill filter 50 has a plurality of blades 51 inclined at a predetermined angle so that a grill flowing path 51a is defined between each of the plurality of blades 51. The air enters the plurality of grill flowing paths 51a while whirling. An inclined angle θ of each of the plurality of blades 51 forms an acute angle with a tangent line shown in FIG. 5. A grill portion 52 has a height of the substantially same as the height of the porous filter 70. A cylindrical part 56 is formed above the grill portion 52, and has a base plate 53 formed at a top end of the cylindrical part 56 in a substantially circular shape with a predetermined height. The cylindrical part 56 is a cylindrical shape with no openings so that the air cannot enter the cylindrical part 56 except the grill portion 52 of the grill filter 50. Because the cylindrical part 56 (that the air cannot enter) is disposed above the grill portion 52 (that the air can enter), as shown in FIG. 6, when the outside air entering and whirling inside the cyclone body 20 through the entering pipe 26 crashes against the cylindrical part 56 above the grill filter 50, the outside air does not enter the inside of the filter unit 40 and whirls down to a lower side of the cyclone body 20. Referring to FIGS. 4 and 6, when the locking part 60 is coupled to the connection part 22, the base plate 53 formed at the top end of the cylindrical part 56 closely contacts a bottom end 27 of the sinking part 22a so as to isolate the inner space of the cyclone body 20 from outside. The locking part 60 formed at topside of the base plate 53 is connected to the connection part 22 of the cyclone body 20, and includes a pillar 64 and a hooking protrusion 62 projecting from the circumferential surface of the pillar 64. The pillar 64 projects upward from the base plate 53, and the hooking protrusion 62 comprises two hooking protrusions slopingly projecting from the circumferential surface of the pillar 64. When coupling the locking part 60 to the connection part 22 of the cyclone body 20, the user aligns the hooking protrusions 62 with the vertical grooves 23, pushes the hooking protrusions 62 to reach the horizontal groove 25, and then, rotates the locking part 60 so that bottom surfaces 57a of the hooking protrusions 62 are caught by the horizontal groove 25. When separating the locking part 60 from the connection part 22, the user performs the above process in reverse. When the locking part 60 is coupled, the top surface of the base plate 53 closely contacts the bottom end 27 of the connection part 22 so as to seal a connection space. A skirt 54 slopingly projects from a bottom end of the grill portion 52 in a circumferential direction so as to prevent dust from flowing back. In this embodiment, the grill portion 52, the cylindrical part 56, the base plate 53, and the locking part 60 are integrally molded by an injection molding process to form a single piece. The skirt 54 is formed by a separate member and is connected to the bottom end of the grill portion 52. Alternatively, the skirt 54 may be molded integrally with the grill portion 52, the cylindrical part 56, the base plate 53, and the locking part 60.

The porous filter 70, referring to FIGS. 2 and 5, is formed in a substantially hollow cylindrical shape with the air flowing path 110 thereinside, and is disposed between the grill filter 50 and the supporting member 80 so as to separate fine dust. Large dust separated by the grill filter 50 falls into the dust collecting receptacle 90, but fine dust may cling to the outer circumferential surface of the porous filter 70 so as to block air holes of the porous filter 70. As a result, the porous filter 70 needs a periodical clean up. For this end, the grill filter 50, the porous filter 70, and the supporting member 80 are respectively formed as a separate part, and the supporting member 80 is configured to be connected to and separated from the grill filter 50 so that the user can assemble and disassemble the filter unit 40. As a result, it is easy to clean the porous filter 70. In this embodiment, the porous filter 70 is made of a sponge or open celled foam.

The supporting member 80, referring to FIG. 2, includes a cylindrical body 82 and a plate 84 connected to a bottom end of the cylindrical body 82. The cylindrical body 82 is formed in a substantially hollow cylindrical shape and has many openings 83 through which the air easily enters the air flowing path 110 (see FIG. 5) to be discharged to the discharging pipe 95. The plate 84 is formed in a substantially flat plane, and is provided with connection grooves 86 for connecting with connection members (not shown) formed at the bottom surface of the skirt 54. Also, the plate 84 includes a converging part 85 (see FIG. 6) for guiding the air entering the air flowing path 110 inside the supporting member 80 to flow to the discharging pipe 95. Referring to FIG. 6, the converging part 85 is configured so that, when the dust collecting receptacle 90 is connected to the bottom end of the cyclone body 20, a bottom end of the converging part 85 is inserted into the discharging pipe 95, thereby isolating the air flowing path 110 from the inner space of the cyclone body 20 and dust collecting receptacle 90. Thus, the converging part 85 has an inner diameter decreasing from a top end to a bottom end so that the inner diameter of the bottom end of the converging part 85 is smaller than the inner diameter of the discharging pipe 95.

Hereinafter, the airflow and dust separating operation of the dust separating apparatus 10 according to an embodiment of the present disclosure will be explained in detail with reference to FIGS. 5 and 6.

FIG. 5 is a sectional view illustrating the dust separating apparatus of FIG. 1 taken along a line 5-5 in FIG. 1, and FIG. 6 is a sectional perspective view illustrating the dust separating apparatus of FIG. 1.

When a vacuum generator (not shown) inside a vacuum cleaner (not shown) generates a suction force, the outside air enters the inner space of the cyclone body 20 through the entering pipe 26, and whirls like arrow A of FIGS. 5 and 6. Some of the entering air bounds from the inner surface of the cyclone body 20 or from the cylindrical part 56 of the grill filter 50 so as to keep whirling downward like arrow B. When the air is whirling, dust and/or contaminant particles contained in the air are separated from the air by the centrifugal force so as to fall into the dust collecting receptacle 90. The air having dust separated re-raises to enter the filter unit 40 as shown by arrows C and D in FIG. 6. At this time, relatively light dust among the dust collected in the dust collecting receptacle 90 raises with the re-raising air. However, the re-raised relatively light dust crashes against the skirt 54, and then, re-falls into the dust-collecting receptacle 90. Furthermore, although the whirling air current affects the dust collected in the dust collecting receptacle 90 to whirl, the plurality of protrusions 91 projecting from the bottom surface of the dust collecting receptacle 90 prevents the dust from whirling.

When the air as shown by arrows C and D in FIG. 6 enters the grill flowing paths 51a between the plurality of blades 51 as shown in FIG. 5, dust or contaminant particles larger than the width of the grill flowing path 51a are filtered so as to fall into the dust collecting receptacle 90. Then, when the air having passed through the grill flowing paths 51a passes through a lot of fine holes of the porous filter 70 in zigzags, fine dust is filtered from the air. Clean air having fine dust filtered enters the air flowing path 110 as arrow F of FIG. 6 via the plurality of openings 83 of the supporting member 80. The clean air entering the air flowing path 110 is discharged to the outside through the discharging pipe 95 as arrow G.

With the dust separating apparatus according to an embodiment of the present disclosure as described above, because the grill filter for filtering large dust and the porous filter for filtering fine dust form a compact filter unit, the dust collecting efficiency is increased and a compact dust separating apparatus can be provided.

Also, with the dust separating apparatus according to an embodiment of the present disclosure, the filter unit can be separated from the cyclone body and the supporting member can be separated from the filter unit so that it is convenient and easy to maintain and clean the filter.

Furthermore, with the dust separating apparatus according to an embodiment of the present disclosure, the entering pipe is configured to project from the top surface of the cyclone body so that the number of rotations of the outside air can be increased over the conventional dust separating apparatus having the same height. The filter unit is configured to have a closed upper portion so that it is hard for the air entering through the entering pipe to directly enter the filter unit. Therefore, the dust separating apparatus according to the present disclosure has a dust collecting efficiency higher than the conventional dust separating apparatus having the same size.

Also, with the dust separating apparatus according to an embodiment of the present disclosure, the dust collecting receptacle has the handle and is detachably connected to the bottom end of the cyclone body so that it is convenient to empty dust collected in the dust collecting receptacle.

Also, with the dust separating apparatus according to an embodiment of the present disclosure, the discharging pipe is disposed at the bottom surface of the dust separating apparatus so that the length of the air flowing path to the vacuum generator disposed below the dust separating apparatus can be decreased. As a result, the piping pressure loss of the vacuum cleaner can be reduced.

While the embodiments of the present disclosure have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the disclosure.

What is claimed is:

1. A dust separating apparatus comprising:
a cyclone body configured to separate dust from air using centrifugal force, the cyclone body having an entering pipe through which the air enters;
a dust collecting receptacle configured to be detachably connected to a bottom end of the cyclone body, the duct collecting receptacle collecting dust separated from the air; and
a filter unit configured to be detachably disposed to the cyclone body,
wherein the filter unit has a compact, at least double structure formed by a first filter for filtering large dust and a second filter for filtering fine dust.

2. The dust separating apparatus of claim 1, wherein the first filter comprises a grill filter for filtering large dust and the second filter comprises a porous filter disposed inside the grill filter.

3. The dust separating apparatus of claim 2, wherein the filter unit further comprises a supporting member for supporting the porous filter.

4. The dust separating apparatus of claim 3, wherein each of the grill filter, the porous filter, and the supporting member is formed in a substantially cylindrical shape with an air flowing path thereinside.

5. The dust separating apparatus of claim 3, wherein the porous filter is disposed between the grill filter and the supporting member,
wherein the supporting member is configured to be mounted on or separated from the grill filter.

6. The dust separating apparatus of claim 2, wherein the grill filter comprises:
a grill part through which the air enters; and
a cylindrical part disposed above the grill part and through which the air cannot enter.

7. The dust separating apparatus of claim 6, wherein the grill filter further comprises:
a locking part disposed at a top end of the cylindrical part and configured to be connected to or separated from the cyclone body.

8. The dust separating apparatus of claim 2, wherein the grill filter further comprises:
a skirt projecting from a bottom end of a circumferential surface of the grill filter and preventing dust from flowing back.

9. The dust separating apparatus of claim 1, wherein at least a part of the entering pipe projects from a top surface of the cyclone body.

10. The dust separating apparatus of claim 1, wherein the dust collecting receptacle comprises a discharging pipe projecting from a center of a bottom surface of the dust collecting receptacle, and
wherein the discharging pipe is detachably connected to a bottom end of the filter unit so as to guide the air flowing out the filter unit to be discharged outside.

11. A dust separating apparatus comprising:
a cyclone body configured to separate dust from air using a whirling air current, the cyclone body having a top surface and a bottom end;
an entering pipe through which the air enters the cyclone body, at least a part of the entering pipe projecting from the top surface;
a dust collecting receptacle configured to be detachably connected to the bottom end;
a discharging pipe projecting upwardly from a center of the inside of the dust-collecting receptacle, the cyclone body being is in fluid communication with an outside via the discharging pipe;
a filter unit configured to be detachably disposed on the discharging pipe within the cyclone body, the filter unit having a grill filter for filtering large dust and a porous filter disposed inside the grill filter for filtering fine dust.

12. The dust separating apparatus of claim 11, wherein the grill filter comprises:
a grill part through which the air enters; and
a cylindrical part disposed above the grill part and through which the air cannot enter.

13. The dust separating apparatus of claim 12, wherein the grill part further comprises a plurality of blades having a flow path defined between each of the plurality of blades.

14. The dust separating apparatus of claim 13, wherein the plurality of blades are inclined in a direction opposite the whirling air current.
